(19) United States
(12) Patent Application Publication
(10) Pub. No.: US 2014/0112312 A1
(43) Pub. Date: Apr. 24, 2014

(54) METHOD FOR TRANSMITTING SIGNAL USING PLURALITY OF CODEWORDS IN WIRELESS COMMUNICATION SYSTEM AND TRANSMISSION END FOR SAME

(71) Applicants: Hakseong Kim, Anyang-si (KR); Hanbyul Seo, Anyang-si (KR); Byounghoon Kim, Anyang-si (KR); Kijun Kim, Anyang-si (KR); Inkwon Seo, Anyang-si (KR)

(72) Inventors: Hakseong Kim, Anyang-si (KR); Hanbyul Seo, Anyang-si (KR); Byounghoon Kim, Anyang-si (KR); Kijun Kim, Anyang-si (KR); Inkwon Seo, Anyang-si (KR)

(73) Assignee: LG ELECTRONICS INC., Seoul (KR)

(21) Appl. No.: 14/116,664

(22) PCT Filed: May 11, 2012
(86) PCT No.: PCT/KR2012/003709

§ 371 Date: Nov. 8, 2013

Related U.S. Application Data
(60) Provisional application No. 61/485,105, filed on May 11, 2011.
(60) Provisional application No. 61/486,740, filed on May 16, 2011.

(51) Int. Cl. H04L 5/00

(52) U.S. Cl. CPC H04L 5/003
USPC 370/335

(57) ABSTRACT

A method for transmitting a signal using a plurality of codewords in a wireless communication system and a transmission end for same are disclosed. The method for the transmission end transmitting the signal using the plurality of codewords, according to the present invention, comprises the following steps: mapping a first codeword on at least one layer from a first layer group and mapping a second codeword on at least one layer from a second layer group, when transmitting a rank of at least five; and transmitting the codewords which are mapped on the first and second layer groups, wherein each of the first layer group and the second layer group can include four layers.

### FIELD OF THE INVENTION

The present invention relates to wireless communication, and more particularly to a method for transmitting a signal using a plurality of codewords and a transmission end for the same.

### BACKGROUND ART

Wireless communication systems have been widely used to provide various kinds of communication services such as voice or data services. Generally, a wireless communication system is a multiple access system that can communicate with multiple users by sharing available system resources (bandwidth, transmission (Tx) power, and the like). A variety of multiple access systems can be used. For example, a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency-Division Multiple Access (SC-FDMA) system, a Multi-Carrier Frequency Division Multiple Access (MC-FDMA) system, and the like.

### DETAILED DESCRIPTION OF THE INVENTION

### Technical Problem

An object of the present invention is to provide a method for transmitting a signal using a plurality of codewords by a transmission end in a wireless communication system.

Another object of the present invention is to provide a transmission end for transmitting a signal using a plurality of codewords in a wireless communication system.

It is to be understood that technical objects to be achieved by the present invention are not limited to the aforementioned technical objects and other technical objects which are not mentioned herein will be apparent from the following description to one of ordinary skill in the art to which the present invention pertains.

### Technical Solution

The object of the present invention can be achieved by providing a method for transmitting a signal using a plurality of codewords by a transmission end in a wireless communication system including: in case of transmission of at least Rank 5, mapping a first codeword to at least one layer from among a first layer group, and mapping a second codeword to at least one layer from among a second layer group; and transmitting codewords mapped to the first and second layer groups. Each of the first layer group and the second layer group may include four layers. The first layer group may include Layer 0 having a layer index 0, Layer 1 having a layer index 1, Layer 2 having a layer index 2, and Layer 3 having a layer index 3; and the second layer group may include Layer 4 having a layer index 4, Layer 5 having a layer index 5, Layer 6 having a layer index 6, and Layer 7 having a layer index 7. The transmission end may be a base station (BS).

In case of transmission of Rank 5, the first codeword may be mapped to 2, 3 or 4 layers from among the first layer group, and the second codeword may be mapped to 1, 2, or 3 layers from among the second layer group.

In case of transmission of Rank 6, the first codeword may be mapped to 3 or 4 layers from among the first layer group, and the second codeword may be mapped to 2 or 3 layers from among the second layer group.

In case of transmission of Rank 7, the first codeword may be mapped to 3 or 4 layers from among the first layer group, and the second codeword may be mapped to 3 or 4 layers from among the second layer group.

The first codeword and the second codeword to layers may be mapped in units of a resource element (RE).

In accordance with another aspect of the present invention, a transmission end for transmitting a signal using a plurality of codewords by a transmission end in a wireless communication system includes: a processor, in case of transmission of at least Rank 5, configured to map a first codeword to at least one layer from among a first layer group, and map a second codeword to at least one layer from among a second layer group; and a transmitter configured to transmit codewords mapped to the first and second layer groups. Each of the first layer group and the second layer group may include four layers. The first layer group may include Layer 0 having a layer index 0, Layer 1 having a layer index 1, Layer 2 having a layer index 2, and Layer 3 having a layer index 3; and the second layer group may include Layer 4 having a layer index 4, Layer 5 having a layer index 5, Layer 6 having a layer index 6, and Layer 7 having a layer index 7. The transmission end may be a base station (BS).

### Effects of the Invention

As is apparent from the above description, the embodiments of the present invention can solve the problem in which it is impossible to perform early decoding of a DL grant due to an increased number of spreading factors generated in a scheme for mapping a legacy codeword to a layer, and can improve communication throughput by efficiently mapping a plurality of codewords to a layer.

It will be appreciated by persons skilled in the art that the effects that can be achieved with the present invention are not limited to what has been particularly described hereinabove and other advantages of the present invention will be more clearly understood from the following detailed description taken in conjunction with the accompanying drawings.

### BRIEF DESCRIPTION OF THE DRAWINGS

The accompanying drawings, which are included to provide a further understanding of the invention, illustrate embodiments of the invention and together with the description serve to explain the principle of the invention.

FIG. 1 is a block diagram illustrating a transmission end and a reception end for use in a wireless communication system.

FIG. 2 is a diagram illustrating a structure of a radio frame used in a 3GPP LTE system as an exemplary mobile communication system.

FIG. 3 is an exemplary structural diagram illustrating downlink and uplink subframes for use in a 3GPP LTE system as an exemplary mobile communication system.

FIG. 4 shows a downlink (DL) time-frequency resource grid structure for use in a 3GPP LTE system.

FIG. 5 is a conceptual diagram illustrating an exemplary rule for mapping M codewords (M CWs) to N layers by a transmission end (e.g., base station).

FIG. 6 is a conceptual diagram illustrating an exemplary method for mapping one codeword (1 CW) to 2 layers by a transmission end.

FIG. 7 is a conceptual diagram illustrating another exemplary method for mapping one codeword (1 CW) to 2 layers by a transmission end.

FIG. 8 is a conceptual diagram illustrating another exemplary method for mapping one codeword (1 CW) to 2 layers by a transmission end.

FIGS. 9A and 9B are conceptual diagrams illustrating a method for RE-mapping/transmitting a PDSCH to other ports at an arbitrary slot where the transmission end transmits an R-PDCCH (or A-PDCCH, ePDCCH, etc.) through a specific port (e.g., Port #7).

FIG. 10 is a conceptual diagram illustrating a PDSCH RE mapping scheme used when the transmission end maps the R-PDCCH or the like to Port/Layer #1.

FIG. 11 is a conceptual diagram illustrating a method for mapping a PDSCH to other layers when the transmission end maps the R-PDCCH or the like to layers (e.g., Layer #2) different from those of FIG. 10.

FIG. 12 is a conceptual diagram illustrating the codeword mapping problem encountered by the spreading operation between cross-slots when codewords (CWs) are mapped to layers in the LTE-A system.

FIGS. 13 to 16 are conceptual diagrams illustrating exemplary mapping schemes capable of solving the problem encountered when codewords (CWs) of FIG. 12 are mapped to layers.

### BEST MODE FOR CARRYING OUT THE INVENTION

Reference will now be made in detail to the preferred embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the present invention. The following detailed description includes specific details in order to provide a thorough understanding of the present invention. However, it will be apparent to those skilled in the art that the present invention may be practiced without such specific details. For example, the following description will be given centering upon a mobile communication system serving as a 3GPP LTE or LTE-A system, but the present invention is not limited thereto and the remaining parts of the present invention other than unique characteristics of the 3GPP LTE or LTE-A system are applicable to other mobile communication systems.

In some cases, in order to prevent ambiguity of the concepts of the present invention, conventional devices or apparatuses well known to those skilled in the art will be omitted and be denoted in the form of a block diagram on the basis of important functions of the present invention. Wherever possible, the same reference numbers will be used throughout the drawings to refer to the same or like parts.

In the following description, a terminal may refer to a mobile or fixed user equipment (UE), for example, a user equipment (UE), a mobile station (MS) and the like. Also, the base station (BS) may refer to an arbitrary node of a network end which communicates with the above terminal, and may include an eNode B (eNB), a Node B (Node-B), an access point (AP) and the like. Although the embodiments of the present invention are disclosed on the basis of 3GPP LTE, LTE-A systems for convenience of description, contents of the present invention can also be applied to other communication systems.

In a mobile communication system, the UE may receive information from the base station (BS) via a downlink, and may transmit information via an uplink. The information that is transmitted and received to and from the UE includes data and a variety of control information. A variety of physical channels are used according to categories of transmission (Tx) and reception (Rx) information of the UE.

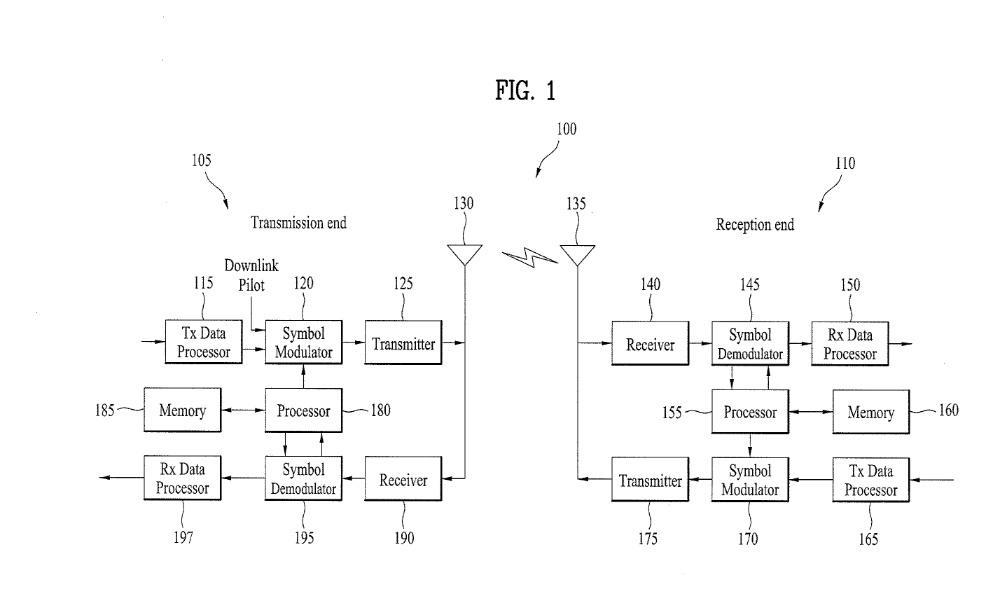

FIG. 1 is a block diagram illustrating a transmission end 105 and a reception end 110 for use in a wireless communication system 100 according to the present invention.

Although FIG. 1 shows one transmission end 105 and one reception end 110 for brief description of the wireless communication system 100, it should be noted that the wireless communication system 100 may further include one or more transmission ends and/or one or more reception ends.

Referring to FIG. 1, the transmission end 105 may include a transmission (Tx) data processor 115, a symbol modulator 120, a transmitter 125, a transmission/reception antenna 130, a processor 180, a memory 185, a receiver 190, a symbol demodulator 195, and a reception (Rx) data processor 197. The reception end 110 may include a Tx data processor 165, a symbol modulator 170, a transmitter 175, a transmission/reception antenna 135, a processor 155, a memory 160, a receiver 140, a symbol demodulator 155, and a Rx data processor 150. In FIG. 1, although one antenna 130 is used for the transmission end 105 and one antenna 135 is used for the reception end 110, each of the transmission end 105 and the reception end 110 may also include a plurality of antennas as necessary. Therefore, the transmission end 105 and the reception end 110 according to the present invention support a Multiple Input Multiple Output (MIMO) system. The transmission end 105 according to the present invention can support both a Single User-MIMO (SU-MIMO) scheme and a Multi User-MIMO (MU-MIMO) scheme.

In downlink, the Tx data processor 115 receives traffic data, formats the received traffic data, codes the formatted traffic data, and interleaves the coded traffic data, and modulates the interleaved data (or performs symbol mapping upon the interleaved data), such that it provides modulation symbols (i.e., data symbols). The symbol modulator 120 receives and processes the data symbols and pilot symbols, such that it provides a stream of symbols.

The symbol modulator 120 multiplexes data and pilot symbols, and transmits the multiplexed data and pilot symbols to the transmitter 125. In this case, each transmission (Tx) symbol may be a data symbol, a pilot symbol, or a value of a zero signal (null signal). In each symbol period, pilot symbols may be successively transmitted during each symbol period. The pilot symbols may be an FDM symbol, an OFDM symbol, a Time Division Multiplexing (TDM) symbol, or a Code Division Multiplexing (CDM) symbol.

The transmitter 125 receives a stream of symbols, converts the received symbols into one or more analog signals, and additionally adjusts the one or more analog signals (e.g., amplification, filtering, and frequency upconversion of the analog signals), such that it generates a downlink signal appropriate for data transmission through an RF channel. Subsequently, the downlink signal is transmitted to the RN through the antenna 130. The Tx antenna 130 transmits the generated DL signal to the UE.

Configuration of the reception end 110 will hereinafter be described in detail. The Rx antenna 135 of the reception end 110 receives a DL signal from the transmission end 105, and transmits the DL signal to the receiver 140. The receiver 140 performs adjustment (e.g., filtering, amplification, and frequency downconversion) of the received DL signal, and digitizes the adjusted signal to obtain samples. The symbol demodulator 145 demodulates the received pilot symbols, and provides the demodulated result to the processor 155 to perform channel estimation.

The symbol demodulator 145 receives a frequency response estimation value for downlink from the processor 155, demodulates the received data symbols, obtains data symbol estimation values (indicating estimation values of the transmitted data symbols), and provides the data symbol estimation values to the Rx data processor 150. The Rx data processor 150 performs demodulation (i.e., symbol-demapping) of data symbol estimation values, deinterleaves the demodulated result, decodes the deinterleaved result, and recovers the transmitted traffic data.

The processing of the symbol demodulator 145 and the Rx data processor 150 is complementary to that of the symbol modulator 120 and the Tx data processor 115 in the transmission end 105.

The Tx data processor 165 of the reception end 110 processes traffic data in uplink, and provides data symbols. The symbol modulator 170 receives and multiplexes data symbols, and modulates the multiplexed data symbols, such that it can provide a stream of symbols to the transmitter 175. The transmitter 175 receives and processes the stream of symbols to generate an uplink (UL) signal, and the UL signal is transmitted to the transmission end 105 through the Tx antenna 135.

The transmission end 105 receives the UL signal from the UE 110 through the antenna 130. The receiver processes the received UL signal to obtain samples. Subsequently, the symbol demodulator 195 processes the symbols, and provides pilot symbols and data symbol estimation values received via uplink. The Rx data processor 197 processes the data symbol estimation value, and recovers traffic data received from the reception end 110.

Processor 155 or 180 of the reception end 110 or the transmission end 105 commands or indicates operations of the reception end 110 or the transmission end 105. For example, the processor 155 or 180 of the reception end 110 or the transmission end 105 controls, adjusts, and manages operations of the reception end 110 or the transmission end 105. Each processor 155 or 180 may be connected to a memory unit 160 or 185 for storing program code and data. The memory 160 or 185 is connected to the processor 155 or 180, such that it can store the operating system, applications, and general files.

The processor 155 or 180 may also be referred to as a controller, a microcontroller), a microprocessor, a microcomputer, etc. In the meantime, the processor 155 or 180 may be implemented by various means, for example, hardware, firmware, software, or a combination thereof In a hardware configuration, methods according to the embodiments of the present invention may be implemented by the processor 155 or 180, for example, one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In a firmware or software configuration, methods according to the embodiments of the present invention may be implemented in the form of modules, procedures, functions, etc. which perform the above-described functions or operations. Firmware or software implemented in the present invention may be contained in the processor 155 or 180 or the memory unit 160 or 185, such that it can be driven by the processor 155 or 180.

Radio interface protocol layers among the reception end 110, the transmission end 105, and a wireless communication system (i.e., network) can be classified into a first layer (L1 layer), a second layer (L2 layer) and a third layer (L3 layer) on the basis of the lower three layers of the Open System Interconnection (OSI) reference model widely known in communication systems. A physical layer belonging to the first layer (L1) provides an information transfer service through a physical channel. A Radio Resource Control (RRC) layer belonging to the third layer (L3) controls radio resources between the UE and the network. The reception end 110 and the transmission end 105 may exchange RRC messages with each other through the wireless communication network and the RRC layer. For example, the transmission end 105 may be a base station (BS), and the reception end 110 may be a UE or a relay node (RN). If necessary, the reception end 110 may operate as the BS, and the transmission end 105 may operate as a UE or RN.

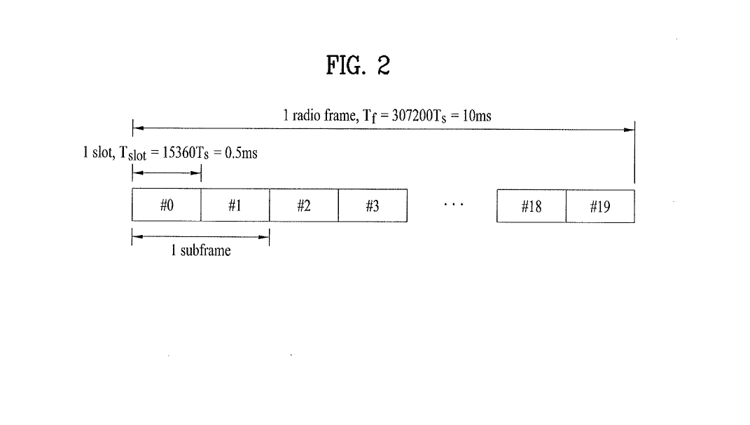

FIG. 2 is a diagram illustrating a structure of a radio frame used in a 3GPP LTE system acting as a mobile communication system.

Referring to FIG. 2, the radio frame has a length of 10 ms (327200*Tₛ) and includes 10 subframes of equal size. Each subframe has a length of 1 ms and includes two slots. Each slot has a length of 0.5 ms (15360×Tₛ). In this case, Tₛ represents a sampling time, and is expressed by ‘Tₛ=1/(15 kHz*2048)=3.2552×10⁻⁸ (about 33 ns)’. The slot includes a plurality of OFDM or SC-FDMA symbols in a time domain, and includes a plurality of resource blocks (RBs) in a frequency domain.

In the LTE system, one resource block includes twelve (12) subcarriers *seven (or six) OFDM (Orthogonal Frequency Division Multiplexing) symbols. A Transmission Time Interval (TTI) which is a transmission unit time of data can be determined in a unit of one or more subframes. The aforementioned structure of the radio frame is only exemplary, and various modifications can be made to the number of subframes contained in the radio frame or the number of slots contained in each subframe, or the number of OFDM or SC-FDMA symbols in each slot.

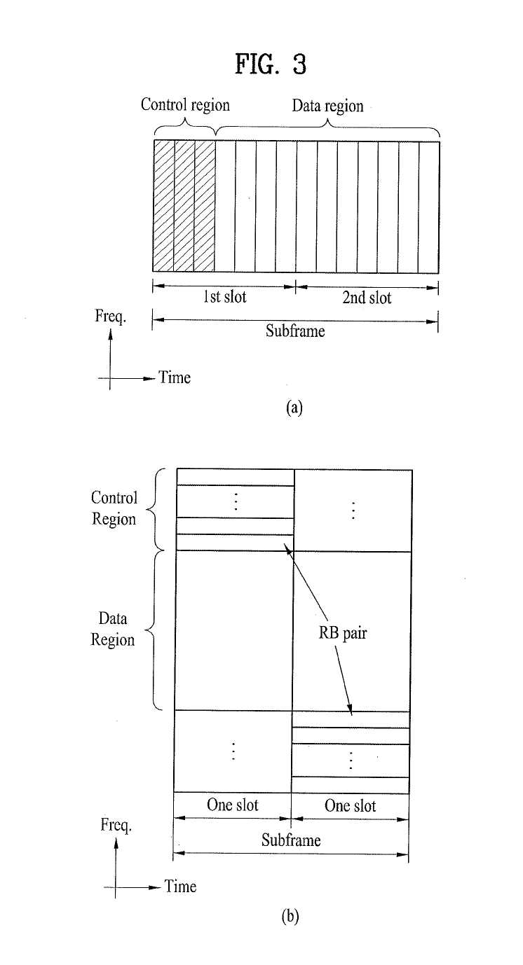

FIG. 3 is an exemplary structural diagram illustrating downlink and uplink subframes for use in a 3GPP LTE system as an exemplary mobile communication system according to the present invention.

Referring to FIG. 3(a), one downlink subframe includes two slots in a time domain. A maximum of three OFDM symbols located in the front of the downlink subframe are used as a control region to which control channels are allocated, and the remaining OFDM symbols are used as a data region to which a Physical Downlink Shared Channel (PDSCH) channel is allocated.

DL control channel for use in the 3GPP LTE system includes a Physical Control Format Indicator CHannel (PCFICH), a Physical Downlink Control Channel (PDCCH), a Physical Hybrid-ARQ Indicator CHannel (PHICH), and the like. The traffic channel includes a Physical Downlink Shared CHannel (PDSCH). PCFICH transmitted through a first OFDM symbol of the subframe may carry information about the number of OFDM symbols (i.e., the size of control region) used for transmission of control channels within the subframe. Control information transmitted through PDCCH is referred to as downlink control information (DCI). The DCI may indicate UL resource allocation information, DL resource allocation information, UL transmission power control commands of arbitrary UE groups, etc. PHICH may carry ACK (Acknowledgement)/NACK (Not-Acknowledgement) signals about an UL Hybrid Automatic Repeat Request (UL HARQ). That is, the ACK/NACK signals about UL data transmitted from the UE are transmitted over PHICH.

PDCCH serving as a downlink physical channel will hereinafter be described in detail.

A base station (BS) may transmit information about resource allocation and transmission format (UL grant) of the PDSCH, resource allocation information of the PUSCH, information about Voice over Internet Protocol (VoIP) activation, etc. A plurality of PDCCHs may be transmitted within the control region, and the UE may monitor the PDCCHs. Each PFCCH includes an aggregate of one or more contiguous control channel elements (CCEs). The PDCCH composed of the aggregate of one or more contiguous CCEs may be transmitted through the control region after performing subblock interleaving. CCE is a logical allocation unit for providing a coding rate based on a Radio frequency (RF) channel status to the PDCCH. CCE may correspond to a plurality of resource element groups. PDCCH format and the number of available PDCCHs may be determined according to the relationship between the number of CCEs and the coding rate provided by CCEs.

Control information transmitted over PDCCH is referred to as downlink control information (DCI). The following Table 1 shows DCIs in response to DCI formats.

TABLE 1

| DCI Format | Description |
|---|---|
| DCI format 0 | used for the scheduling of PUSCH |
| DCI format 1 | used for the scheduling of one PDSCH codeword |
| DCI format 1A | used for the compact scheduling of one PDSCH |
| | codeword and random access procedure initiated by a |
| | PDCCH order |
| DCI format 1B | used for the compact scheduling of one PDSCH |
| | codeword with precoding information |
| DCI format 1C | used for very compact scheduling of one PDSCH |
| | codeword |
| DCI format 1D | used for the compact scheduling of one PDSCH |
| | codeword with precoding and power offset |
| | information |
| DCI format 2 | used for scheduling PDSCH to UEs configured in |
| | closed-loop spatial multiplexing mode |
| DCI format 2A | used for scheduling PDSCH to UEs configured in |
| | open-loop spatial multiplexing mode |
| DCI format 3 | used for the transmission of TPC commands for |
| | PUCCH and PUSCH with 2-bit power |
| | adjustments |
| DCT format 3A | used for the transmission of TPC commands for |
| | PUCCH and PUSCH with single bit power |
| | adjustments |

In Table 1, DCI format 0 may indicate uplink resource allocation information. DCI format 1 and DCI format 2 may indicate downlink resource allocation information. DCI format 3 and DCI format 3A may indicate uplink transmit power control (TPC) commands for arbitrary UE groups.

A method for allowing a BS to perform resource mapping for PDCCH transmission in the LTE system will hereinafter be described in detail.

Generally, the BS may transmit scheduling allocation information and other control information to the UE over the PDCCH. A physical control channel (PDCCH) is configured in the form of one aggregate (one aggregation) or several CCEs, and is transmitted as one aggregate or several CCEs. One CCE includes 9 resource element groups (REGs). The number of RBGs unallocated to either Physical Control Format Indicator Channel (PCFICH) or Physical Hybrid Automatic Repeat Request Indicator Channel (PHICH) is N_{RB}. CCEs from 0 to N_{CCE}-1 may be available to a system (where, N_{CCE}=ØN_{REG}/9┘). PDCCH supports multiple formats as shown in the following Table 2. One PDCCH composed of n contiguous CCEs begins with a CCE having ‘i mod n=0’ (where ‘i’ is a CCE number). Multiple PDCCHs may be transmitted through one subframe.

TABLE 2

| PDCCH | Number of | Number of resource- | Number of |
|---|---|---|---|
| format | CCEs | element groups | PDCCH bits |
| 0 | 1 | 9 | 72 |
| 1 | 2 | 18 | 144 |
| 2 | 4 | 36 | 288 |
| 3 | 8 | 72 | 576 |

Referring to Table 2, an eNode B (eNB) may decide a PDCCH format according to how many regions are required for the BS to transmit control information. The UE reads control information and the like in units of a CCE, resulting in reduction of overhead. Likewise, a relay node (RN) may read control information or the like in units of R-CCE or CCE. In the LTE-A system, a resource element (RC) may be mapped in units of a Relay Control Channel Element (R-CCE) or CCE so as to transmit an R-PDCCH for an arbitrary RN.

Referring to FIG. 3(b), an uplink (UL) subframe may be divided into a control region and a data region in a frequency domain. The control region may be assigned to a Physical Uplink Control Channel (PUCCH) carrying uplink control information (UCI). The data region may be assigned to a Physical Uplink Shared Channel (PUSCH) carrying user data. In order to maintain single carrier characteristics, one UE does not simultaneously transmit PUCCH and PUSCH. PUCCH for one UE may be assigned to a Resource Block (RB) pair in one subframe. RBs of the RB pair occupy different subcarriers in two slots. The RB pair assigned to PUCCH performs frequency hopping at a slot boundary.

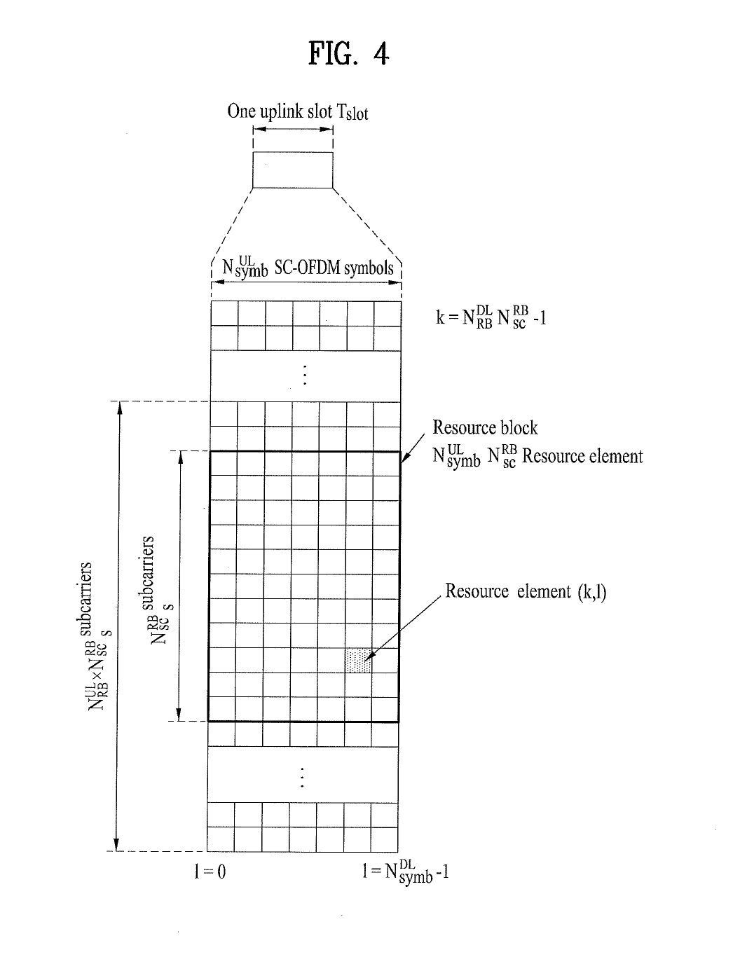

FIG. 4 shows a downlink (DL) time-frequency resource grid structure for use in a 3GPP LTE system.

Referring to FIG. 4, downlink transmission resources can be described by a resource grid including N_{RB}^{DL}×N_{SC}^{RB} subcarriers and N_{symb}^{DL} OFDM symbols. Here, N_{RB}^{DL} represents the number of resource blocks (RBs) in a downlink, N_{SC}^{RB} represents the number of subcarriers constituting one RB, and N_{symb}^{DL} represents the number of OFDM symbols in one downlink slot. N_{RB}^{DL} varies with a downlink transmission bandwidth constructed in a cell, and must satisfy N_{RB}^{min,DL}≦N_{RB}^{DK}≦N_{RB}^{max,DL}. Here, N_{RB}^{min,DL} is the smallest downlink bandwidth supported by the wireless communication system, and N_{RB}^{max,DL} is the largest downlink bandwidth supported by the wireless communication system. Although N_{RB}^{min, DL} may be set to 6 (N_{RB}^{min,DL}=6) and N_{RB}^{max,DL} may be set to 110 (N_{RB}^{max,DL}=110), the scopes of N_{RB}^{min, UL} and N_{RB}^{max,UL} are not limited thereto. The number of OFDM symbols contained in one slot may be differently defined according to the length of a Cyclic Prefix (CP) and spacing between subcarriers. When transmitting data or information via multiple antennas, one resource grid may be defined for each antenna port.

Each element contained in the resource grid for each antenna port is called a resource element (RE), and can be identified by an index pair (k, l) contained in a slot, where k is an index in a frequency domain and is set to any one of 0, . . . , N_{RB}^{DL}N_{sc}^{RB}−1, and l is an index in a time domain and is set to any one of 0, . . . , N_{symb}^{DL}−1.

Resource blocks (RBs) shown in FIG. 4 are used to describe a mapping relationship between certain physical channels and resource elements (REs). The RBs can be classified into physical resource blocks (PRBs) and virtual resource blocks (VRBs). One PRB is defined by N_{symb}^{DL} consecutive OFDM symbols in a time domain and N_{SC}^{RB} consecutive subcarriers in a frequency domain. N_{symb}^{DL} and N_{SC}^{RB} may be predetermined values, respectively. For example, N_{symb}^{DL} and N_{SC}^{RB} may be given as shown in the following Table 1. Therefore, one PRB may be composed of N_{symb}^{DL}×N_{SC}^{RB} resource elements. One PRB may correspond to one slot in a time domain and may also correspond to 180 kHz in a frequency domain, but it should be noted that the scope of the present invention is not limited thereto.

TABLE 3

| | | |
|---|---|---|
| Configuration | N_{sc}^{RB} | N_{symb}^{DL} |

| | | | |
|---|---|---|---|
| Normal | Δf = 15 kHz | 12 | 7 |
| cyclic prefix | | | |
| Extended | Δf = 15 kHz | | 6 |
| cyclic prefix | Δf = 7.5 kHz | 24 | 3 |

The PRBs are assigned numbers from 0 to N_{RB}^{DL}−1 in the frequency domain. A PRB number n_{PRB} and a resource element index (k,l) in a slot can satisfy a predetermined relationship denoted by

$${n}_{PRB} = ⌊ \frac{k}{{N}_{sc}^{RB}} ⌋ .$$

The VRB may have the same size as that of the PRB. The VRB may be classified into a localized VRB (LVRB) and a distributed VRB (DVRB). For each VRB type, a pair of PRBs allocated over two slots of one subframe is assigned a single VRB number n_{VRB}.

The VRB may have the same size as that of the PRB. Two types of VRBs are defined, the first one being a localized VRB (LVRB) and the second one being a distributed type (DVRB). For each VRB type, a pair of PRBs may have a single VRB index (which may hereinafter be referred to as a ‘VRB number’) and are allocated over two slots of one subframe. In other words, N_{RB}^{DL} VRBs belonging to a first one of two slots constituting one subframe are each assigned any one index of 0 to N_{RB}^{DL}−1, and N_{RB}^{DL} VRBs belonging to a second one of the two slots are likewise each assigned any one index of 0 to N_{RB}^{DL}−1.

The radio frame structure, the downlink subframe, the uplink subframe, and the downlink time-frequency resource grid structure shown in FIGS. 2 to 4 may also be applied between a base station (BS) and a relay node (RN).

A method for allowing the BS to transmit a PDCCH to a user equipment (UE) in an LTE system will hereinafter be described in detail. The BS determines a PDCCH format according to a DCI to be sent to the UE, and attaches a Cyclic Redundancy Check (CRC) to control information. A unique identifier (e.g., a Radio Network Temporary Identifier (RNTI)) is masked onto the CRC according to PDCCH owners or utilities. In case of a PDCCH for a specific UE, a unique ID of a user equipment (UE), for example, C-RNTI (Cell-RNTI) may be masked onto CRC. Alternatively, in case of a PDCCH for a paging message, a paging indication ID (for example, R-RNTI (Paging-RNTI)) may be masked onto CRC. In case of a PDCCH for system information (SI), a system information ID (i.e., SI-RNTI) may be masked onto CRC. In order to indicate a random access response acting as a response to an UE's random access preamble transmission, RA-RNTI (Random Access—RNTI) may be masked onto CRC. The following Table 4 shows examples of IDs masked onto PDCCH and/or R-PDCCH.

TABLE 4

| Type | Identifier | Description |
|---|---|---|
| UE-specific | C-RNTI | used for the UE corresponding to the |
| | | C-RNTI. |
| Common | P-RNTI | used for paging message. |
| | SI-RNTI | used for system information (It could be |
| | | differentiated according to the type of system |
| | | information). |
| | RA-RNTI | used for random access response (It could be |
| | | differentiated according to subframe or |
| | | PRACH slot index for UE PRACH |
| | | transmission). |
| | TPC-RNTI | used for uplink transmit power control |
| | | command (It could be differentiated |
| | | according to the index of UE TPC |
| | | group). |

If C-RNTI is used, PDCCH may carry control information for a specific UE, and R-PDCCH may carrier control information for a specific RN. If another RNTI is used, PDCCH may carry common control information that is received by all or some UEs contained in the cell, and R-PDCCH may carry common control information that is received by all or some RNs contained in the cell. The BS performs channel coding of the CRC-added DCI so as to generate coded data. The BS performs rate matching according to the number of CCEs allocated to a PDCCH or R-PDCCH format. Thereafter, the BS modulates the coded data so as to generate modulated symbols. In addition, the BS maps the modulated symbols to physical resource elements.

In the current LTE standard, two transmission schemes (i.e., openloop MIMO and closed loop MIMO) configured to operate without channel information are present. In the closed loop MIMO, a transceiver performs beamforming on the basis of channel information (CSI) so as to obtain a multiplexing gain of the MIMO antenna. A base station (BS) allocates a PUCCH or PUSCH to a user equipment (UE) so as to obtain the CSI, such that a downlink CSI may be fed back.

CSI is broadly divided into three pieces of information, i.e. Rank. Indicator (RI), Precoding Matrix Index (PMI), and Channel Quality Indication (CQI). RI may indicate rank information of a channel and may indicate the number of streams received by the UE through the same frequency-time resource. Since RI is dominantly determined by long-term fading of a channel, it is fed back at a cycle longer than that of PMI or CQI. Second, PMI is a value reflecting a spatial characteristic of a channel and indicates a precoding index of the BS preferred by the UE based on a metric such as SINR etc. CQI is a value indicating the strength of a channel and indicates a reception SINR obtainable when the BS generally uses PMI.

In an evolved communication system such as LTE-A, an additional multi-user diversity can be obtained using Multi-User MIMO (MU-MIMO). To this end, higher accuracy is needed in terms of channel feedback. Since an interference channel between UEs multiplexed in an antenna domain is present in the MU-MIMO scheme, feedback channel accuracy may greatly affect not only interference of a UE that has performed feedback but also interference of other multiplexed UEs. In addition, higher channel accuracy is needed for CoMP (Coordinated Multi-Point).

In case of CoMP JT (Joint Processing), several BSs perform coordinated transmission of the same data for a specific UE, such that the corresponding system may be considered a MIMO system in which antennas are geographically distributed. That is, the MU-MIMO in JT may require a higher-level channel accuracy so as to prevent interference between co-scheduled UEs in the same manner as in the single cell MU-MIMO. In case of CoMP CB (Coordinated Beamforming), precise channel information is needed to avoid interference from a contiguous cell to a serving cell.

In order to achieve a high transfer rate in the next-generation communication standard such as LTE-A, transmission schemes such as MU-MIMO and CoMP have been proposed. In order to implement the improved transmission scheme, there is a need for the UE to feed back various CSIs to the BS. For example, when a UE selects a PMI in MU-MIMO, the CSI feedback scheme in which a desired PMI of the UE and a PMI (hereinafter referred to as BCPMI (best companion PMI)) of another UE to be scheduled with the UE has been considered. That is, when the co-scheduled UE is used as a precoder in the precoding matrix codebook, a BCPMI causing less interference to the UE is calculated such that the calculated result is additionally fed back to the BS. The BS performs MU-MIMO scheduling of one UE and another UE that prefers precoding of BCPM (best companion precoding matrix: a precoding matrix corresponding to BCPMI) using the above-mentioned information.

In the following description, the term “layer” may also be referred to as a port or antenna port, etc., and the term “layer index” may be denoted by other numbers different from exemplary numbers shown in the drawing. For example, Layer #1 may be denoted by Layer #7 (or Port #7 or Antenna Port #7), and Layer #2 may be denoted by a different number as in Layer #8 (or Port #8 or Antenna Port #8). Distinction between Layer and Port is considered virtual distinction, and may be subdivided according to an additional ID such as a scrambling ID. The layer marking order (1, 2, 3 . . . , 8) may be changed according to the RE construction and spreading scheme of respective ports. In the above-mentioned description, Layers (1, 2, 3, . . . , 8) may be renumbered in the same order as in Ports (7, 8, 9, . . . 14).

In accordance with the embodiment of the present invention, the Spatial Multiplexing (SM) scheme can be applied to a control channel (for example, Advanced PDCCH(A-PDCCH), Enhanced PDCCH, ePDCCH, or the like) obtained by improvement of a PDCCH channel acting as a control channel for use in the legacy 3GPP LTE system, and codewords (CWs) can be mapped to the above control channel.

In addition, technology of the SM scheme and the CW mapping scheme applied to the improved control channel can also be equally applied to R-PDCCH (Relay-Physical Downlink Control CHannel) of the 3GPP LTE-A system unless otherwise mentioned. Although the above-mentioned description has been disclosed using the term “R-PDCCH” for convenience of description, the scope of the above technology is not limited to a relay or relay node (RN) unless otherwise mentioned, and the above technology can also be applied to the UE and other similar or equivalent devices without difficulty. In this case, R-PDCCH may refer to a backhaul physical downlink control channel for relay transmission from the BS to the RN, and may be used as a control channel for a relay or RN.

In the following description in which a codeword is mapped to at least two layers, assuming that available resources between layers are different from each other, various methods for mapping codeword(s) to at least two layers are proposed. R-PDCCH shown in the drawings may also be located not only at a first slot but also at a second slot. In addition, R-PDCCH may also be located at a specific region composed of a combination of a specific subcarrier and a symbol.

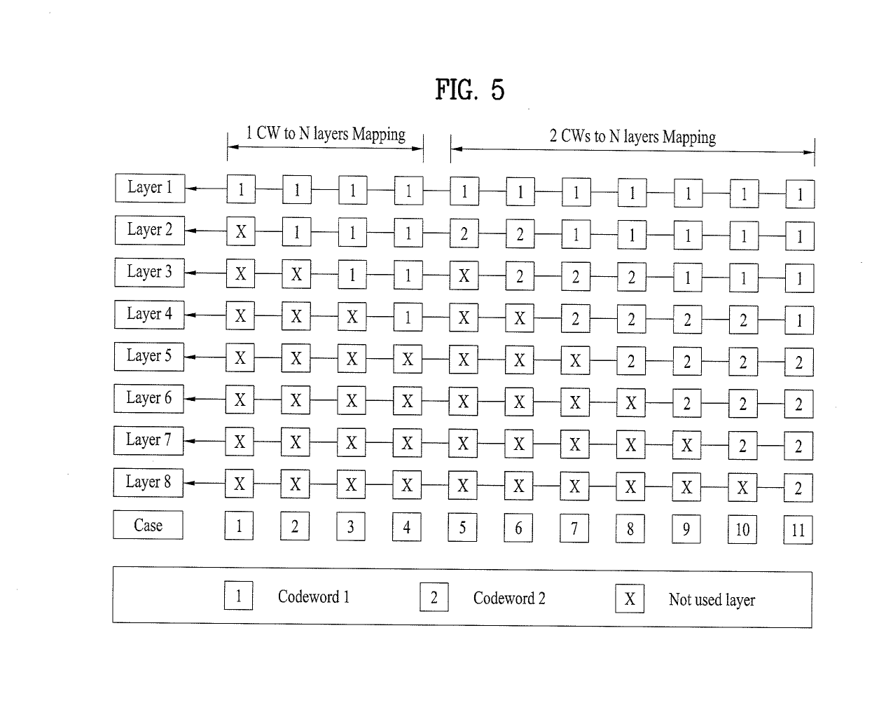

FIG. 5 is a conceptual diagram illustrating an exemplary rule for mapping M codewords (M CWs) to N layers by a transmission end (e.g., base station).

Referring to FIG. 5, under the condition that one CW and one layer are proposed, a transmission end may map one CW to one layer on a one to one basis (Corresponding to Case 1). Under the condition that one CW and two layers are proposed, a transmission end may map one CW to two layers (Corresponding to Case 2). In addition, under the condition that two CWs and two layer are proposed, a transmission end may map two CWs to two layers on a one to one basis (Corresponding to Case 5).

Special CW(s)-to-layer(s) mapping methods are denoted by Case 6 (corresponding to 2 CWs and 3 layers), Case 8 (corresponding to 2 CWs and 5 layers), and Case 10 (corresponding to 2 CWs and 7 layers). In this case, a smaller number of CWs than the number of lower layers by one may be mapped to the lower layers. In the case in which 2 CWs and 3 layers are used, CW #1 may be mapped to Layer #1, and CW #2 may be mapped to Layers #2 and #3.

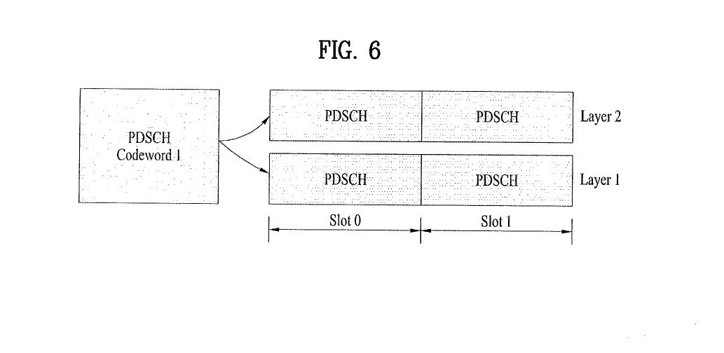

FIG. 6 is a conceptual diagram illustrating an exemplary method for mapping one codeword (1 CW) to 2 layers by a transmission end.

The proposed method will hereinafter be described using the case including 1 CW and 2 Layers as an example with reference to FIG. 6. In FIG. 6, two slots of Layer #1 and Layer #2 may be considered available resources in terms of codeword mapping. In this case, the legacy CW-to-Layer mapping scheme may be applied to the present invention without change.

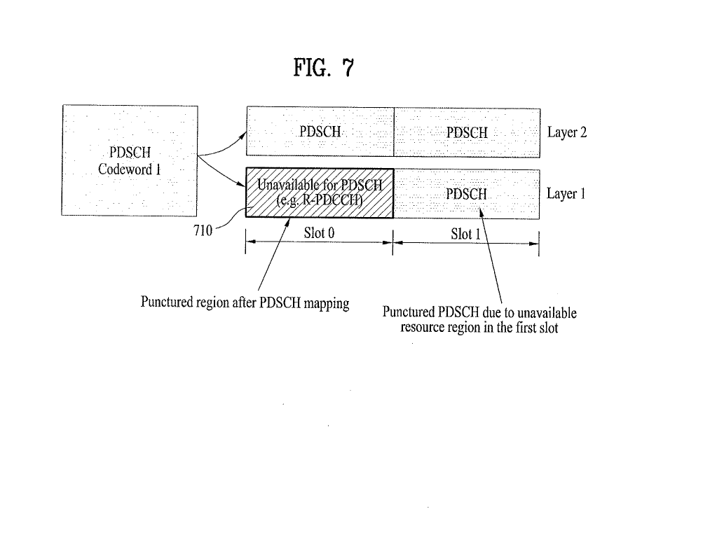

FIG. 7 is a conceptual diagram illustrating another exemplary method for mapping one codeword (1 CW) to 2 layers by a transmission end.

FIG. 7 shows the CW-to-Layer mapping method used when a region incapable of being used for PDSCH transmission exists such that a PDSCH codeword cannot be mapped to a specific region of Layer #1.

In accordance with the CW-to-Layer mapping method shown in FIG. 7, assuming that an unavailable region does not exist, the CW-to-Layer mapping scheme is first performed, and PDSCH puncturing may be applied to an unavailable region 710. In this case, slight performance deterioration may occur due to such puncturing.

In this case, although the unavailable region has been disclosed using an R-PDCCH transmitted in units of a slot as an example, the scope or spirit of the present invention is not limited to R-PDCCH, and may be applied to various improved PDCCHs such as ePDCCH, A-PDCCH, etc. The unavailable region may occupy a resource region in units of a slot or in units of a symbol or RE (Resource Element), or may indicate a specific region incapable of being mapped to a PDSCH due to the presence of a specific resource region established as an unavailable resource region.

However, it may be determined whether or not the method of FIG. 7 will be used according to the size of unavailable region. A threshold value of the unavailable region may be established in different ways according to requirements. Extremely, the threshold value may be set to zero “0” as an example. That is, assuming that the unavailable region includes one or more REs, the puncturing method of FIG. 7 may be used.

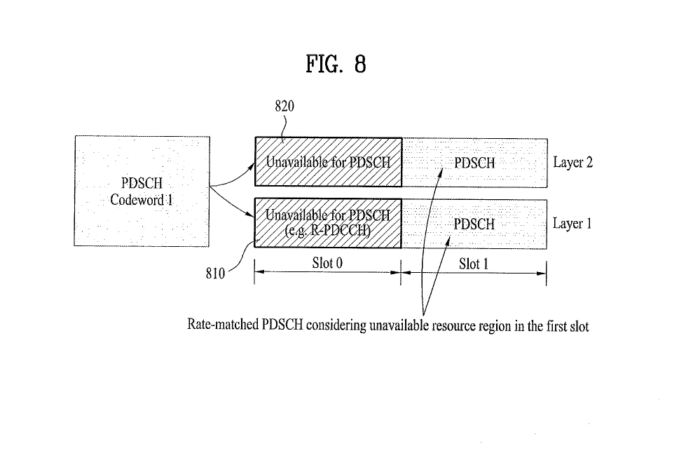

FIG. 8 is a conceptual diagram illustrating another exemplary method for mapping one codeword (1 CW) to 2 layers by a transmission end.

Referring to FIG. 8, although the unavailable regions (810, 820) are present, rate matching is performed without puncturing a PDSCH, because the unavailable regions are equally established in two layers (Layer #1 and Layer #2). That is, assuming that the same-sized unavailable regions (810, 820) are present in layers to be mapped, available regions for PDSCH mapping may have the same size, such that the unequal mapping problem may not occur in the mapping process. Therefore, the mapping method of FIG. 8 is substantially identical to that of FIG. 6.

However, after respective layers recognize such unavailable regions, assuming that there is a little difference in size between the recognized unavailable regions or the recognized unavailable regions have the same size, the transmission end may perform rate matching of a PDSCH in consideration of the corresponding region. Of course, the unavailable regions may be defined in units of any one of a slot, symbol, or RE.

The above-mentioned two methods of FIGS. 7 and 8 (i.e., the puncturing based mapping scheme and the rate-matching based mapping scheme) can be implicitly recognized by a reception end (for example, UE or relay), and the transmission end may explicitly inform the reception end of the above two methods through signaling (for example, physical layer (PHY) signaling or higher layer signaling).

In addition, although two methods can be implicitly or explicitly selected, it is more preferable that one of the two methods be fixedly used.

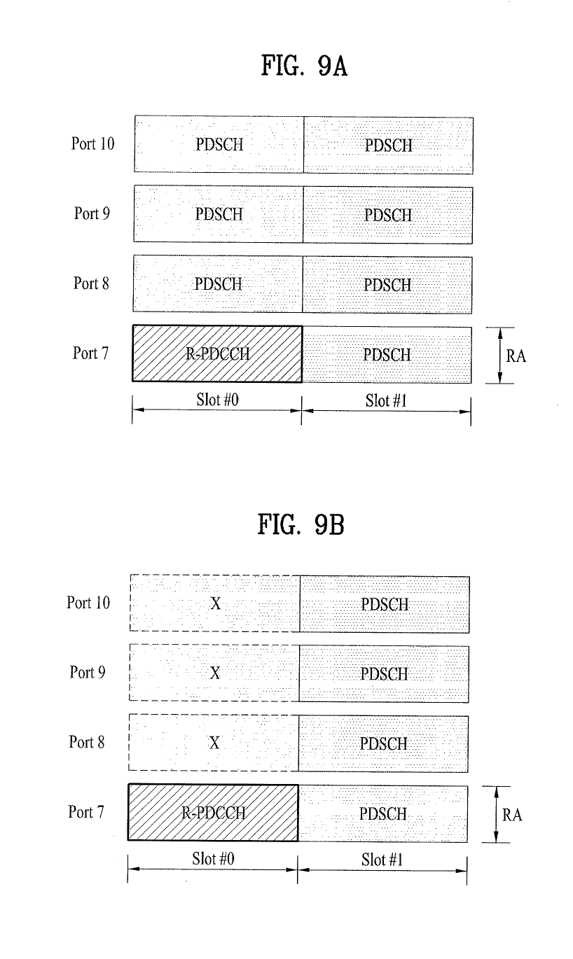

FIGS. 9A and 9B are conceptual diagrams illustrating a method for RE-mapping/transmitting a PDSCH to other ports at an arbitrary slot where the transmission end transmits an R-PDCCH (or A-PDCCH, ePDCCH, etc.) through a specific port (e.g., Port #7).

In FIG. 9(a), assuming that the transmission end transmits an R-PDCCH at a first slot through Port #7, a PDSCH may be mapped in units of an RE (hereinafter referred to as ‘RE mapping’), irrespective of transmission or non-transmission of R-PDCCH to another layer or port of the corresponding slot.

Since R-PDCCH transmission and PDSCH transmission occur in the same slot, interference occurs between layers, such that R-PDCCH decoding throughput may be slightly deteriorated. However, a PDSCH can be mapped to many more spatial domains. However, considering the above-mentioned R-PDCCH throughput deterioration, a gain acquired by the increasing PDSCH transmission capacity may be relatively restricted.

In FIG. 9(b), assuming that the transmission end transmits the R-PDCCH to a specific port (e.g., Port #7) of a specific slot (e.g., Slot #0), PDSCH mapping for the corresponding slot is shown in FIG. 9(b). In this case, the transmission end does not map a PDSCH to another port (Port #8, Port #9, Port #10) or another layer (Layer #8, Layer #9, Layer #10) of the same slot (Slot #0) so as not to provide interference to the R-PDCCH. As a result, the probability of correctly receiving the R-PDCCH by the reception end can be increased.

Although the two methods shown in FIG. 9(a) and FIG. 9(b) are applied to an RB region including the R-PDCCH, the two methods need not always be applied to the remaining regions other than the RB region.

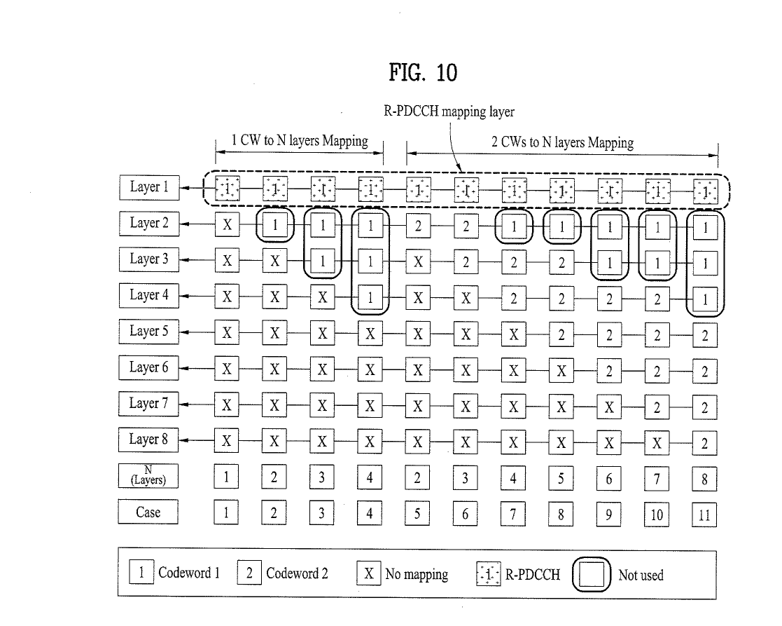

FIG. 10 is a conceptual diagram illustrating a PDSCH RE mapping scheme used when the transmission end maps the R-PDCCH or the like to Port/Layer #1.

In more detail, FIG. 10 shows a method for performing PDSCH mapping under the condition that R-PDCCH (or A-PDCCH, ePDCCH, etc.) is mapped to Layer #1 or Port #1 in a system based on the CW-to-Layer mapping rule. In FIG. 10, ‘1’ may indicate that a layer is mapped to Codeword #1 (CW1), and ‘2’ may indicate that a layer mapped to Codeword #2 (CW2).

Referring to FIG. 10, the transmission end (for example, BS) may map one codeword (1 CW) to a plurality of layers.

In FIG. 10, ‘X’ may indicate that a PDSCH codeword is not mapped to the corresponding layer. If the R-PDCCH (or A-PDCCH, ePDCCH, etc.) is mapped to Layer #1 (e.g., Antenna Port #7) by the transmission end, Layer #1 and other layers participating in CW1 transmission are not used for PDSCH mapping. If the transmission end maps Codeword #1 (CW1) to Layer #N and Layer #M, and R-PDCCH (or A-PDCCH, ePDCCH, etc.) is transmitted to Layer #N, a PDSCH is not mapped to Layer #M.

In FIG. 10, assuming that only Codeword #1 (CW1) is present and 4 layers are transmitted (Corresponding to Case 4), and Layer #1 is applied to R-PDCCH transmission, Layer #2, Layer #3, and Layer #4 are not applied to PDSCH transmission.

In another example, assuming that 3 layers are used to transmit Codeword #1 (CW1) and Codeword #2 (CW2) (Corresponding to Case 6), although an R-PDCCH (or A-PDCCH, ePDCCH, etc.) is mapped to Layer #1 by the system in which the transmission end maps CW1 to Layer #1 simultaneously with mapping CW2 to Layers #2 and #3, Layer #2 and Layer #3 are layers mapped to CW2, such that a PDSCH CW2 may be mapped to Layer #2 and Layer #3. As a result, the amount of interference generated in R-PDCCH (or A-PDCCH, ePDCCH, etc.) can decrease and the resource use efficiency can increase.

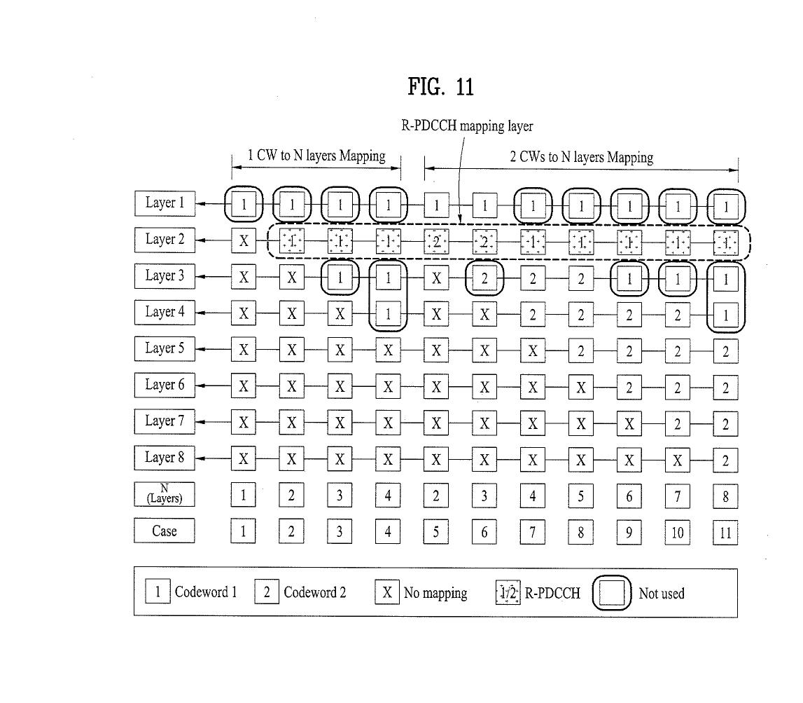

FIG. 11 is a conceptual diagram illustrating a method for mapping a PDSCH to other layers when the transmission end maps the R-PDCCH or the like to layers (e.g., Layer #2) different from those of FIG. 10.

Referring to FIG. 11, Layer #2 may indicate a DM RS Port #8 in LTE-A standard. In this case, assuming that the same codeword is mapped to a plurality of layers as shown in FIG. 10 and the transmission end maps (or transmits) at least one of the layers to R-PDCCH (or A-PDCCH, ePDCCH, etc.), a PDSCH is not mapped to the remaining layers other than the layer mapped to R-PDCCH (or A-PDCCH, ePDCCH, etc.).

For example, assuming that the transmission end transmits only one codeword (CW1) to three layers (Corresponding to Case 3), CW1 may be mapped to Layer #1, Layer #2, and Layer #3, and the transmission end maps the R-PDCCH (or A-PDCCH, ePDCCH, etc.) to Layer #2, Layer #1 and Layer #3 are not used for PDSCH transmission.

In another example, assuming that the transmission end transmits CW1 and CW2 to three layers (Corresponding to Case 6), and R-PDCCH (or A-PDCCH, ePDCCH, etc.) is mapped to Layer #2 by the system in which CW1 is mapped to Layer #1 and CW2 is mapped to Layer #2 and Layer #3, CW2 is mapped to Layer #2 and Layer #3, such that CW2 is not mapped to Layer #3.

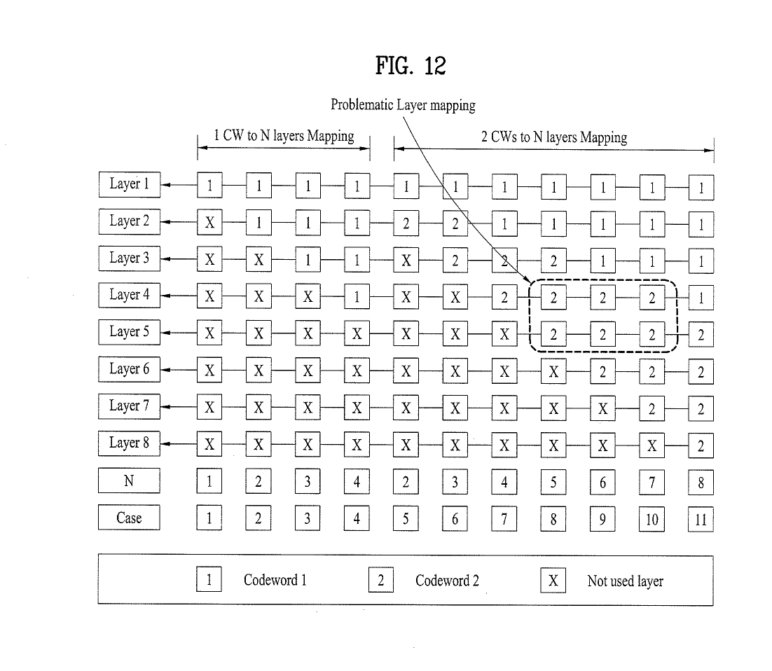

FIG. 12 is a conceptual diagram illustrating the codeword mapping problem encountered by the spreading operation between cross-slots when codewords (CWs) are mapped to layers in the LTE-A system.

The codeword-to-layer mapping scheme for the spatial multiplexing for use in 3GPP LTE standard has been defined as shown in Table 5 (See TS36.211 V10.1.0, Table 6.3.3.2-1)

TABLE 5

| | | Codeword-to-layer mapping | |
|---|---|---|---|
| Number of layers | Number of codewords | i = 0, 1, . . . , M_{symb}^{layer} − 1 | |
| 1 | 1 | x⁽⁰⁾(i) = d⁽⁰⁾(i) | M_{symb}^{layer} = M_{symb}⁽⁰⁾ |
| 2 | 1 | x⁽⁰⁾(i) = d⁽⁰⁾(2i) | M_{symb}^{layer} = M_{symb}⁽⁰⁾/2 |
| | | x⁽¹⁾(i) = d⁽⁰⁾(2i + 1) | |
| 2 | 2 | x⁽⁰⁾(i) = d⁽⁰⁾(i) | M_{symb}^{layer} = M_{symb}⁽⁰⁾ = M_{symb}⁽¹⁾ |
| | | x⁽¹⁾(i) = d⁽¹⁾(i) | |
| 3 | 1 | x⁽⁰⁾(i) = d⁽⁰⁾(3i) | M_{symb}^{layer} = M_{symb}⁽⁰⁾/3 |
| | | x⁽¹⁾(i) = d⁽⁰⁾(3i + 1) | |
| | | x⁽²⁾(i) = d⁽⁰⁾(3i + 2) | |
| 3 | 2 | x⁽⁰⁾(i) = d⁽⁰⁾(i) | M_{symb}^{layer} = M_{symb}⁽⁰⁾ = M_{symb}⁽¹⁾/2 |
| | | x⁽¹⁾(i) = d⁽¹⁾(2i) | |
| | | x⁽²⁾(i) = d⁽¹⁾(2i + 1) | |
| 4 | 1 | x⁽⁰⁾(i) = d⁽⁰⁾(4i) | M_{symb}^{layer} = M_{symb}⁽⁰⁾/4 |
| | | x⁽¹⁾(i) = d⁽⁰⁾(4i + 1) | |
| | | x⁽²⁾(i) = d⁽⁰⁾(4i + 2) | |
| | | x⁽³⁾(i) = d⁽⁰⁾(4i + 3) | |
| 4 | 2 | x⁽⁰⁾(i) = d⁽⁰⁾(2i) | M_{symb}^{layer} = M_{symb}⁽⁰⁾/2 = M_{symb}⁽¹⁾/2 |
| | | x⁽¹⁾(i) = d⁽⁰⁾(2i + 1) | |
| | | x⁽²⁾(i) = d⁽¹⁾(2i) | |
| | | x⁽³⁾(i) = d⁽¹⁾(2i + 1) | |
| 5 | 2 | x⁽⁰⁾(i) = d⁽⁰⁾(2i) | M_{symb}^{layer} = M_{symb}⁽⁰⁾/2 = M_{symb}⁽¹⁾/3 |
| | | x⁽¹⁾(i) = d⁽⁰⁾(2i + 1) | |
| | | x⁽²⁾(i) = d⁽¹⁾(3i) | |
| | | x⁽³⁾(i) = d⁽¹⁾(3i + 1) | |
| | | x⁽⁴⁾(i) = d⁽¹⁾(3i + 2) | |
| 6 | 2 | x⁽⁰⁾(i) = d⁽⁰⁾(3i) | M_{symb}^{layer} = M_{symb}⁽⁰⁾/3 = M_{symb}⁽¹⁾/3 |
| | | x⁽¹⁾(i) = d⁽⁰⁾(3i + 1) | |
| | | x⁽²⁾(i) = d⁽⁰⁾(3i + 2) | |
| | | x⁽³⁾(i) = d⁽¹⁾(3i) | |
| | | x⁽⁴⁾(i) = d⁽¹⁾(3i + 1) | |
| | | x⁽⁵⁾(i) = d⁽¹⁾(3i + 2) | |
| 7 | 2 | x⁽⁰⁾(i) = d⁽⁰⁾(3i) | M_{symb}^{layer} = M_{symb}⁽⁰⁾/3 = M_{symb}⁽¹⁾/4 |
| | | x⁽¹⁾(i) = d⁽⁰⁾(3i + 1) | |
| | | x⁽²⁾(i) = d⁽⁰⁾(3i + 2) | |
| | | x⁽³⁾(i) = d⁽¹⁾(4i) | |
| | | x⁽⁴⁾(i) = d⁽¹⁾(4i + 1) | |
| | | x⁽⁵⁾(i) = d⁽¹⁾(4i + 2) | |
| | | x⁽⁶⁾(i) = d⁽¹⁾(4i + 3) | |
| 8 | 2 | x⁽⁰⁾(i) = d⁽⁰⁾(4i) | M_{symb}^{layer} = M_{symb}⁽⁰⁾/4 = M_{symb}⁽¹⁾/4 |
| | | x⁽¹⁾(i) = d⁽⁰⁾(4i + 1) | |
| | | x⁽²⁾(i) = d⁽⁰⁾(4i + 2) | |
| | | x⁽³⁾(i) = d⁽⁰⁾(4i + 3) | |
| | | x⁽⁴⁾(i) = d⁽¹⁾(4i) | |
| | | x⁽⁵⁾(i) = d⁽¹⁾(4i + 1) | |
| | | x⁽⁶⁾(i) = d⁽¹⁾(4i + 2) | |
| | | x⁽⁷⁾(i) = d⁽¹⁾(4i + 3) | |

As can be seen from Table 5, 2 codewords (2 CWs) are transmitted in transmission of Ranks (or Layers) #5˜8, and individual codewords are distributed and transmitted to a plurality of layers according to ranks. Two codewords (2 CWs) are denoted by CW1 and CW2, and 8 layers are denoted by Layers #1˜8.

A value obtained when ‘1’ is applied to each index of Table 5 is identical to the index of the embodiment. That is, during Rank-5 transmission, CW1 is mapped to Layer #1 and Layer #2, and CW2 is mapped to Layers #3˜5. In case of Rank-6 transmission, CW1 is mapped to Layers #1˜3 and CW2 is mapped to Layers #4˜6 in the same manner as in Rank-5 transmission. In case of Rank-7 transmission, CW1 is mapped to Layers #1˜3 and CW2 is mapped to Layers #4˜6.

In accordance with the above-mentioned codeword-to-layer mapping scheme, during transmission of at least Rank #5, for Codeword #2 (CW2), DM RS transmission increases to the spreading factor ‘4’ at a second slot of a PRB pair to which a DL grant is transmitted, such that it is impossible to perform early decoding of the DL grant during the at least Rank #5 transmission. That is, assuming that one codeword (1 CW) is mapped between a lower layer part (1, 2, 3, 4,) and an upper layer part (5, 6, 7, 8), a decoding throughput may be deteriorated. In FIG. 12, the above-mentioned problem occurs when CW2 is transmitted all over Layer #4 and Layer #5 in the same manner as in Case 8, Case 9, or Case 10.

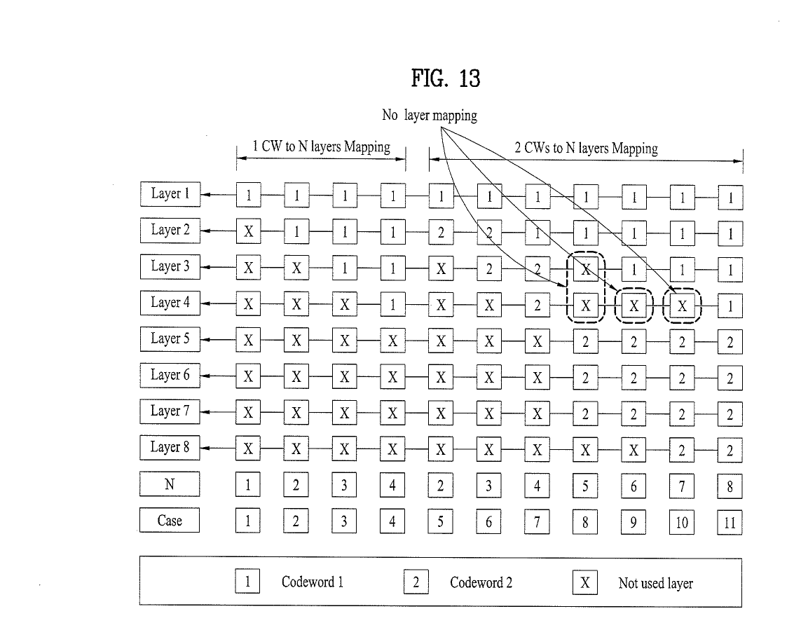

FIGS. 13 to 16 are conceptual diagrams illustrating exemplary mapping schemes capable of solving the problem encountered when codewords (CWs) of FIG. 12 are mapped to layers.

FIGS. 13 to 16 are conceptual diagrams illustrating modification of the conventional method in which layers are classified into Layer Group 1 (Layers 1, 2, 3, 4) and Layer Group 2 (Layers 5, 6, 7, 8) and codewords (CWs) are RE-mapped all over both layer groups, such that the method schemes of FIGS. 13 to 16 show codewords (CWs) mapped to layer groups. For example, Codeword 1 (CW1) is always RE-mapped only in Layers 1,2,3,4 of Layer Group 1, and Codeword 2 (CW2) is always RE-mapped only in Layers 5,6,7,8 of Layer Group 2.

Referring to Case 8, Case 9, and Case 10 of FIG. 12, Case 8 to 10 have a common problem in which CW2 is mapped throughout Layer 4 of a lower layer part and Layer 5 of a higher layer part. In order to solve the above-mentioned problem, Case 8 of FIG. 13 shows that the transmission end may map CW2 to Layer 6 and Layer 7 without mapping CW2 to Layer 3 and Layer 4, Case 9 shows that CW2 may be mapped to Layer 7 without mapping CW2 to Layer 4, and Case 10 shows that CW2 may be mapped to Layer 8 without mapping CW2 to Layer 4.

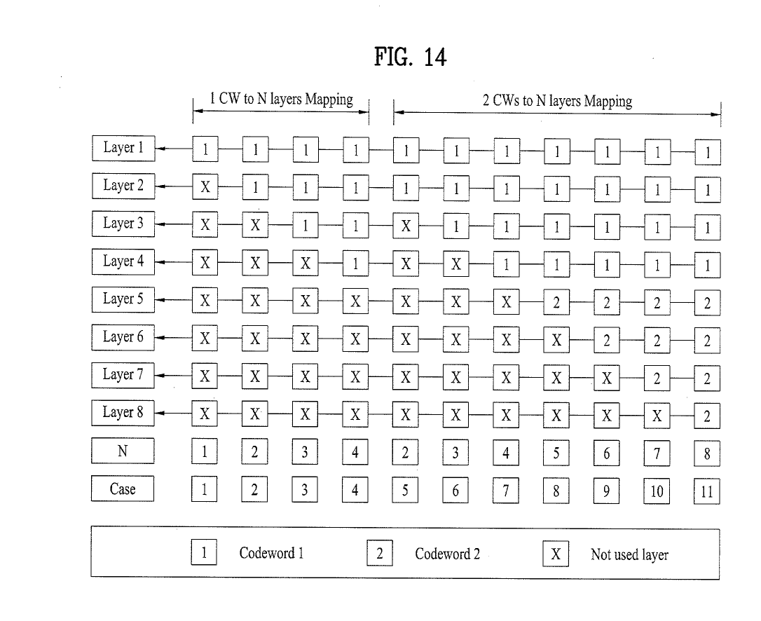

Referring to Case 8 of FIG. 14, CW1 is mapped to Layers 1˜4 and CW2 is mapped to Layer 5. Referring to Case 9 of FIG. 14, CW1 is mapped to Layers 1˜4 and CW2 is mapped to Layers 5˜6. Referring to Case 10 of FIG. 14, CW1 is mapped to Layers 1˜4 and CW2 is mapped to Layers 5˜7.

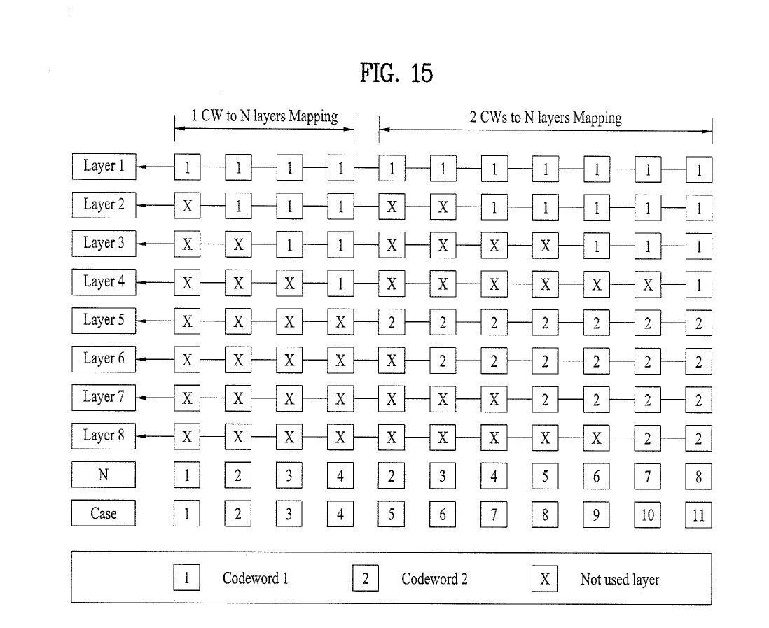

Referring to Case 8 of FIG. 15, CW1 is mapped to Layers 1˜2 and CW2 is mapped to Layers 5˜7. Referring to Case 9 of FIG. 15, CW1 is mapped to Layers 1˜3 and CW2 is mapped to Layers 5˜7. Referring to Case 10 of FIG. 15, CW1 is mapped to Layers 1˜3 and CW2 is mapped to Layers 5˜8. If the number of layers mapped to CW1 is different from the number of layers mapped to CW2 as shown in FIG. 15, CW2 may be mapped to many more layers than those of CW1.

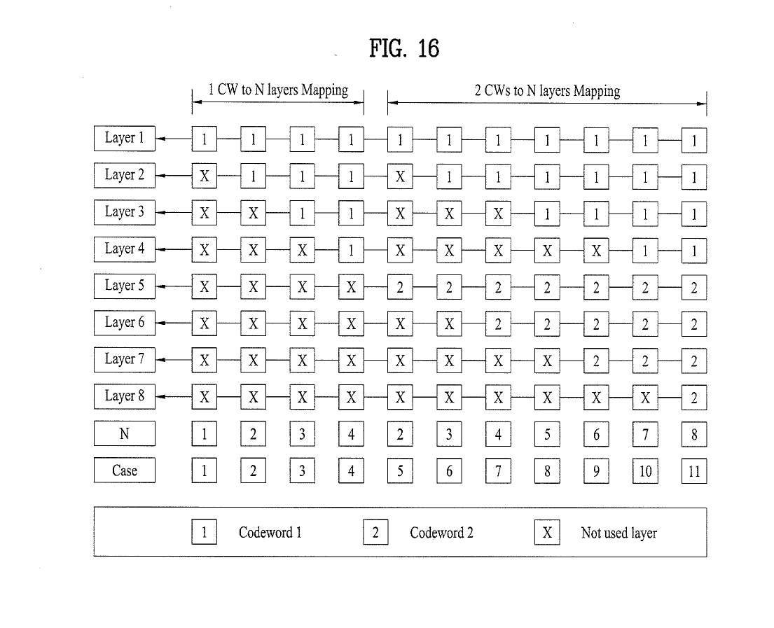

Referring to Case 8 of FIG. 16, CW1 is mapped to Layers 1˜3 and CW2 is mapped to Layers 5˜6. Referring to Case 9 of FIG. 16, CW1 is mapped to Layers 1˜3 and CW2 is mapped to Layers 5˜7. Referring to Case 10 of FIG. 16, CW1 is mapped to Layers 1˜4 and CW2 is mapped to Layers 5˜7. Differently from FIG. 15, if the number of layers mapped to CW1 is different from the number of layers mapped to CW2 as shown in FIG. 16, CW1 may be mapped to many more layers than those of CW2.

In this case, assuming that R-PDCCH (or A-PDCCH, ePDCCH, etc.) is RE-mapped and transmitted to a specific layer of Layer Group 1, the transmission end may allow all layers of Layer Group 1 not to perform PDSCH CW RE mapping. In contrast, assuming that R-PDCCH (or A-PDCCH, ePDCCH, etc.) is mapped to a specific layer of Layer Group 2, the transmission end may not perform PDSCH CW mapping on all layers contained in Layer Group 2.

A method for determining a layer group according to the present invention is only exemplary for convenience of description and better understanding of the present invention, various combinations of grouping may be constructed. If necessary, a different number of layers may be combined for grouping. For example, Layer 1 and Layer 2 may be allocated to Layer Group 1, and Layers 3˜8 may be allocated to Layer Group 2. In addition, the proposed method of the present invention is not significantly different in technical idea from the at least 2CWs-to-Layer RE mapping scheme.

As described above, if retransmission is carried out due to CW reception error, the above-mentioned method may be used without change. However, it is more preferable that PDSCH is not RE-mapped to all layers or ports of a slot to which R-PDCCH (or A-PDCCH, ePDCCH, etc.) is transmitted in consideration of retransmission characteristics.

Likewise, if retransmission is carried out, PDSCH RE mapping may not be mapped to all layers of a layer group corresponding to a layer to which R-PDCCH (or A-PDCCH, ePDCCH, etc.) is transmitted. However, it is more preferable that all layers of a resource region (e.g., slot) to which R-PDCCH (or A-PDCCH, ePDCCH, etc.) is transmitted may not be used for PDSCH RE mapping.

Although multiple layers of the present invention are exemplarily denoted by Layers 1˜8 for convenience of description and better understanding of the present invention, the above Layers 1˜8 may also be denoted by Layer Indexes 0˜7 as necessary. In addition, although multiple codewords (CWs) may be denoted by CW1 and CW2, the above codewords (CWs) may also be denoted by CW Index 0 and CW Index 1 as necessary.

Exemplary embodiments described hereinbelow are combinations of elements and features of the present invention. The elements or features may be considered selective unless mentioned otherwise. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment. Additionally, it will be obvious to those skilled in the art that claims that are not explicitly cited in the appended claims may be presented in combination as an exemplary embodiment of the present invention or included as a new claim by subsequent amendment after the application is filed.

It will be apparent to those skilled in the art that various modifications and variations can be made in the present invention without departing from the spirit or scope of the invention. Therefore, the above-mentioned detailed description must be considered for illustrative purposes only, not restrictive purposes. The scope of the present invention must be decided by a rational analysis of the claims, and all modifications within equivalent ranges of the present invention are within the scope of the present invention.

### INDUSTRIAL APPLICABILITY

The method for transmitting a signal using multiple codewords in a wireless communication system, and a transmission end for the same according to the embodiments of the present invention can be applied to various mobile communication systems, for example, 3GPP LTE, LTE-A, IEEE 802, etc. for industrial purposes.

1. A method for transmitting a signal using a plurality of codewords by a transmission end in a wireless communication system, the method comprising:
in case of transmission of at least Rank 5, mapping a first codeword to at least one layer from among a first layer group, and mapping a second codeword to at least one layer from among a second layer group; and
transmitting codewords mapped to the first and second layer groups.

2. The method according to claim 1, wherein each of the first layer group and the second layer group includes four layers.

3. The method according to claim 2, wherein:
the first layer group includes Layer 0 having a layer index 0, Layer 1 having a layer index 1, Layer 2 having a layer index 2, and Layer 3 having a layer index 3; and
the second layer group includes Layer 4 having a layer index 4, Layer 5 having a layer index 5, Layer 6 having a layer index 6, and Layer 7 having a layer index 7.

4. The method according to claim 1, wherein the transmission end is a base station (BS).

5. The method according to claim 1, wherein:
in case of transmission of Rank 5, the first codeword is mapped to 2, 3 or 4 layers from among the first layer group, and the second codeword is mapped to 1, 2, or 3 layers from among the second layer group.

6. The method according to claim 1, wherein:
in case of transmission of Rank 6, the first codeword is mapped to 3 or 4 layers from among the first layer group, and the second codeword is mapped to 2 or 3 layers from among the second layer group.

7. The method according to claim 1, wherein:
in case of transmission of Rank 7, the first codeword is mapped to 3 or 4 layers from among the first layer group, and the second codeword is mapped to 3 or 4 layers from among the second layer group.

8. The method according to claim 1, wherein the first codeword and the second codeword to layers is mapped in units of a resource element (RE).

9. A transmission end for transmitting a signal using a plurality of codewords in a wireless communication system, the transmitting end comprising:
a processor, in case of transmission of at least Rank 5, configured to map a first codeword to at least one layer from among a first layer group, and map a second codeword to at least one layer from among a second layer group; and
a transmitter configured to transmit codewords mapped to the first and second layer groups.

10. The transmission end according to claim 9, wherein each of the first layer group and the second layer group includes four layers.

11. The transmission end according to claim 10, wherein:
the first layer group includes Layer 0 having a layer index 0, Layer 1 having a layer index 1, Layer 2 having a layer index 2, and Layer 3 having a layer index 3; and
the second layer group includes Layer 4 having a layer index 4, Layer 5 having a layer index 5, Layer 6 having a layer index 6, and Layer 7 having a layer index 7.

12. The transmission end according to claim 9, wherein the transmission end is a base station (BS).
